(19) United States
(12) Patent Application Publication
(10) Pub. No.: US 2023/0067844 A1
(43) Pub. Date: Mar. 2, 2023

(54) INFORMATION PROCESSING APPARATUS, INFORMATION PROCESSING METHOD, PROGRAM, AND INFORMATION PROCESSING SYSTEM

(71) Applicant: SONY GROUP CORPORATION, Tokyo (JP)

(72) Inventors: Katsuya SHIMOJI, Tokyo (JP); Norihiro FUJITA, Kanagawa (JP)

(73) Assignee: SONY GROUP CORPORATION, Tokyo (JP)

(21) Appl. No.: 17/790,670

(22) PCT Filed: Dec. 25, 2020
(86) PCT No.: PCT/JP2020/048724

§ 371 Date: Jul. 1, 2022

(30) Foreign Application Priority Data
Jan. 8, 2020 (JP) 2020-001410

(51) Int. Cl. H04L 9/32; H04L 9/06; H04L 9/08

(52) U.S. Cl. CPC H04L 9/3242; H04L 9/0643; H04L 9/0662; H04L 9/0869

(57) ABSTRACT

There is provided an information processing apparatus, an information processing method, a program, and an information processing system which make it possible to improve the safety of a time variant key. The information processing apparatus according to one aspect of the present technique receives a first random number and a second random number which are transmitted from another information processing apparatus, generates a third random number, generates a first time variant key by causing the second random number and the third random number to act on a first fixed key, encrypts the first random number by using the first time variant key, and transmits the encrypted first random number and the third random number to the another information processing apparatus. The present technique can be applied to an IC card mounted with an IC chip for performing non-contact communication.

### TECHNICAL FIELD

The present technique relates to, in particular, an information processing apparatus, an information processing method, a program, and an information processing system which make it possible to improve the safety of a time variant key.

### BACKGROUND ART

In recent years, payment using an IC card mounted with an IC chip for FeliCa (registered trademark), for example, is typically performed at a store, a ticket gate at a station, etc. A user makes a payment by holding his or her own IC card up to a R/W (Reader/Writer) apparatus.

When the IC card is held up to the R/W apparatus, authentication processing for preventing unauthorized use of the IC card is performed between the IC card and the R/W apparatus. In the authentication processing, authentication is performed by using a key that the IC card and the R/W apparatus have in advance.

PTL 1 discloses a technique for generating a time variant key by using a random number generated in an IC card in order to prevent a key, which is set in the IC card, from being analyzed by a DFA attack.

A DFA (Differential Fault Analysis) attack is a technique for intentionally causing a malfunction at a time of encryption processing and thus specifying a key used in encryption from the difference between a correct cipher text and a cipher text having an error.

### Citation List

### Patent Literature

[PTL 1] Japanese Patent Laid-open No. 2010-45761

### SUMMARY

### Technical Problem

In a case of generating a time variant key by using only a random number generated in an IC card, randomness may decrease due to a malfunction of a random number generator or to the random number being altered in a communication channel. In a case where randomness has decreased and a random number used to generate a time variant key has become a fixed value, there is a risk that a DFA attack will succeed.

The present technique is made in the light of such a situation, and an object thereof is to make it possible to improve the safety of a time variant key.

### Solution to Problem

An information processing apparatus according to a first aspect of the present technique includes a reception unit configured to receive a first random number and a second random number that are transmitted from another information processing apparatus, a random number generation unit configured to generate a third random number, a time variant key generation unit configured to generate a first time variant key by causing the second random number and the third random number to act on a first fixed key, an encryption unit configured to encrypt the first random number by using the first time variant key, and a transmission unit configured to transmit the encrypted first random number and the third random number to the another information processing apparatus.

An information processing apparatus according to a second aspect of the present technique includes a random number generation unit configured to generate a first random number and a second random number, a transmission unit configured to transmit the first random number and the second random number to another information processing apparatus, a reception unit configured to receive, from the another information processing apparatus, a third random number that is generated in the another information processing apparatus and the first random number that is encrypted in the another information processing apparatus by using a first time variant key generated by causing the second random number and the third random number to act on a first fixed key, a time variant key generation unit configured to generate a second time variant key by causing the third random number and the second random number that is generated by the random number generation unit, to act on a second fixed key that is the same fixed key as the first fixed key held by the another information processing apparatus, and an authentication unit configured to decrypt the encrypted first random number by using the second time variant key, and perform authentication processing on the basis of the first random number obtained by being decrypted and the first random number generated by the random number generation unit.

In the first aspect of the present technique, a first random number and a second random number that are transmitted from another information processing apparatus are received, a third random number is generated, a first time variant key is generated by causing the second random number and the third random number to act on a first fixed key, the first random number is encrypted by using the first time variant key, and the encrypted first random number and the third random number are transmitted to the another information processing apparatus.

In the second aspect of the present technique, a first random number and a second random number are generated, the first random number and the second random number are transmitted to another information processing apparatus, and a third random number that is generated in the another information processing apparatus and the first random number that is encrypted in the another information processing apparatus by using a first time variant key generated by causing the second random number and the third random number to act on a first fixed key are received from the another information processing apparatus. In addition, a second time variant key is generated by causing the third random number and the generated second random number to act on a second fixed key that is the same fixed key as the first fixed key held by the another information processing apparatus, the encrypted first random number is decrypted by using the second time variant key, and authentication processing is performed on the basis of first random number obtained by being decrypted and the generated first random number.

### BRIEF DESCRIPTION OF DRAWINGS

FIG. 1 is a view illustrating an example of a configuration of an information processing system according to an embodiment of the present technique.

FIG. 2 is a view illustrating an authentication sequence.

FIG. 3 is a view illustrating an example of wrongdoing.

FIG. 4 is a view illustrating an example of an authentication sequence according to an embodiment of the present technique.

FIG. 5 is a view illustrating another example of wrongdoing.

FIG. 6 is a view for giving a description regarding an effect realized by the authentication sequence in FIG. 4.

FIG. 7 is a view illustrating a sequence in a case of performing MAC one-way authentication.

FIG. 8 is a view illustrating a sequence in a case of performing MAC mutual authentication.

FIG. 9 is a view illustrating a sequence that continues from FIG. 8.

FIG. 10 is a view illustrating a sequence in a case of performing MAC mutual authentication and reading and writing data.

FIG. 11 is a view illustrating a sequence that continues from FIG. 10.

FIG. 12 is a view illustrating a sequence in a case of performing MAC mutual authentication and reading and writing encrypted data.

FIG. 13 is a view illustrating a sequence that continues from FIG. 12.

FIG. 14 is a block view illustrating an example of a configuration of an IC card.

FIG. 15 is a block view illustrating an example of a configuration of an R/W apparatus.

FIG. 16 is a block view illustrating an example of a configuration of a computer.

### DESCRIPTION OF EMBODIMENTS

Description is given below regarding aspects for implementing the present technique. The description is given in the following order.
1. Configuration of information processing system
2. Authentication sequence
3. Application examples
4. Apparatus configurations
5. Modifications

### Configuration of Information Processing System

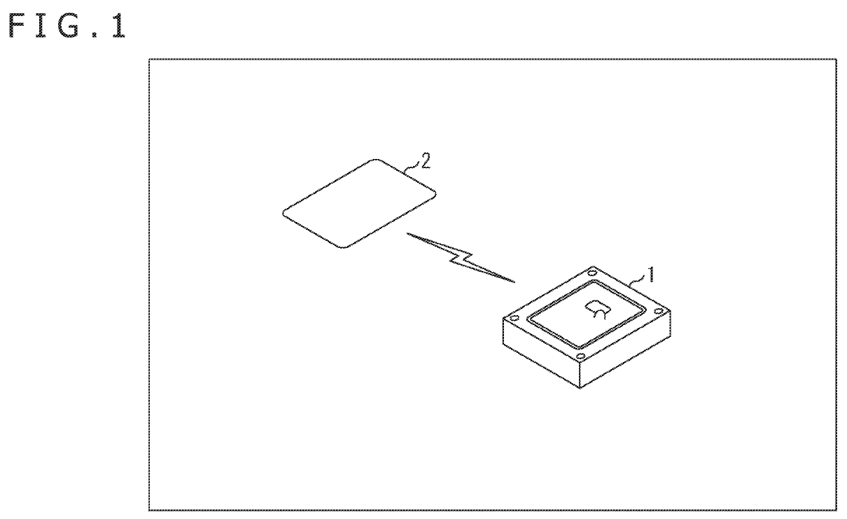

FIG. 1 is a view illustrating an example of a configuration of an information processing system according to an embodiment of the present technique.

As illustrated in FIG. 1, the information processing system according to the embodiment of the present technique includes an R/W apparatus 1 and an IC card 2. The R/W apparatus 1 is, as appropriate, connected to a computer which is not illustrated.

The IC card 2 is a card to which is mounted a non-contact type IC chip for FeliCa (registered trademark), for example. When the IC card 2 is held up to the R/W apparatus 1, non-contact proximity communication is performed between the R/W apparatus 1 and the IC card 2, and various types of processing are performed in the IC card 2 according to a command transmitted from the R/W apparatus 1.

For example, in a case where a Read command is transmitted, information stored in an IC chip in the IC card 2 is read out, and the information read out is transmitted to the R/W apparatus 1 as a response. In addition, in a case where a Write command is transmitted, information stored in an IC chip in the IC card 2 is updated, and information representing that the update succeeded is transmitted to the R/W apparatus 1 as a response.

Description is given below regarding authentication processing performed between the R/W apparatus 1 and the IC card 2. The following terms are used, as appropriate, in the description of the authentication processing.

IDm

: Manufacture ID. A unique ID for each IC chip in the IC card 2

Ra, Rb, Rc, Rd

: Random numbers

Cipher text = ENC_{K}(Plain text): a cryptographic operation (encryption) using a key K is performed on a plain text to thereby obtain a cipher text

Plain text = DEC_{K}(Cipher text)

: a cryptographic operation (decryption) using the key K is performed on a cipher text to thereby obtain a plain text

Message = MAC_{K}(Plain text)

: a cryptographic operation (MAC) using the key K is performed on a plain text to thereby obtain a MAC (Message Authentication Code)

K′ = KDF_{K}(a,b)

: parameters a and b and a key derivation function (KDF) are used to obtain a derived key K′ from the key K

? A == B

: A and B are compared to thereby obtain an authentication result

A | | B

: a value obtained by joining A and B

### Authentication Sequence

### Authentication Sequence

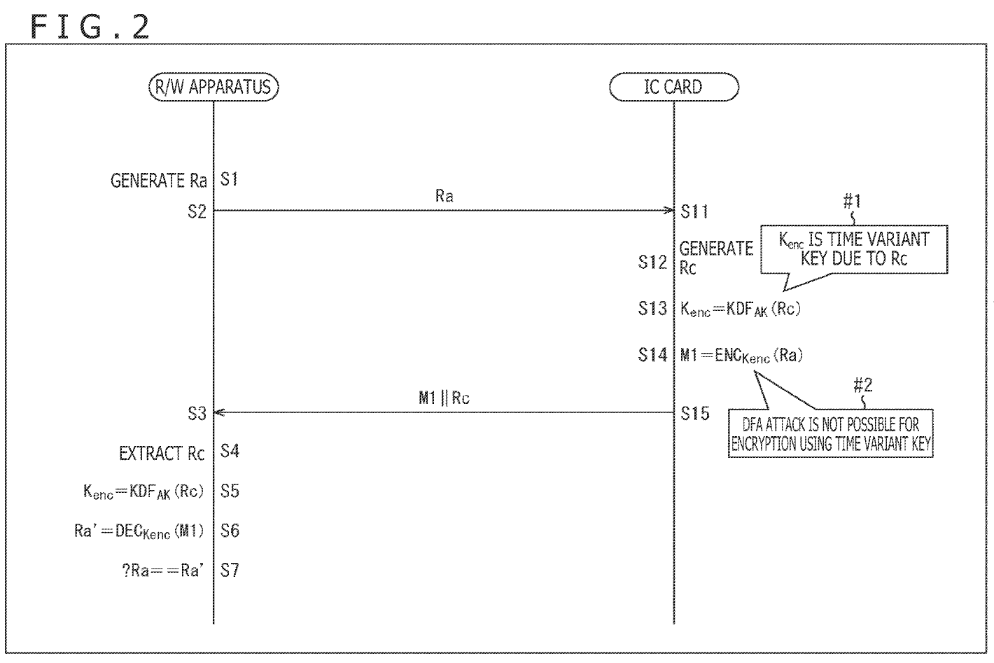

FIG. 2 is a view illustrating an authentication sequence. Processing similar to authentication processing based on the sequence illustrated in FIG. 2 is described in PTL 1, for example.

In step S1, the R/W apparatus 1 generates a random number Ra. A random number generator for generating the random number Ra is provided in the R/W apparatus 1.

In step S2, the R/W apparatus 1 transmits the random number Ra to the IC card 2.

In step S11, the IC card 2 receives the random number Ra transmitted from the R/W apparatus 1.

In step S12, the IC card 2 generates a random number Rc. A random number generator for generating the random number Rc is provided in the IC card 2.

In step S13, the IC card 2 uses the random number Rc and a function KDF to generate a key K_{enc} on the basis of a key AK. The key K_{enc} is represented by the following formula (1). Generation of the key K_{enc} is processing in which the key AK is caused to act on the random number Rc. Note that the key AK is a shared fixed key (Preshared Key) that is held in advance by both the R/W apparatus 1 and the IC card 2.

### [Math. 1]

$${\text{K}}_{\text{enc}} = {\text{KDF}}_{\text{AK}} \left(\text{Rc}\right)$$

As indicated in a speech balloon #1, because the newly generated random number Rc is used, the key K_{enc} generated using the random number Rc is a time variant key.

In step S14, the IC card 2 performs a cryptographic operation using the key K_{enc} on the random number Ra transmitted from the R/W apparatus 1 in order to generate a message M1. The message M1 is represented by the following formula (2). The cryptographic operation performed in the IC card 2 using the key K_{enc} is encryption processing.

[Math. 2]

$$\text{M1} = {\text{ENC}}_{{\text{K}}_{\text{enc}}} \left(\text{Ra}\right)$$

Because the key used to generate the message M1 is a time variant key, a state in which a DFA attack using the message M1 is not possible is entered, as indicated in a speech balloon #2.

In step S15, the IC card 2 joins and transmits the message M1 and the random number Rc.

In step S3, the R/W apparatus 1 receives the message M1 and the random number Rc transmitted from the IC card 2.

In step S4, the R/W apparatus 1 extracts the random number Rc from the received information.

In step S5, the R/W apparatus 1 causes the key AK to act on the random number Rc to thereby generate the key K_{enc}. The key K_{enc} is represented by the following formula (3).

[Math. 3]

$${\text{K}}_{\text{enc}} = {\text{KDF}}_{\text{AK}} \left(\text{Rc}\right)$$

In step S6, the R/W apparatus 1 performs a cryptographic operation using the key K_{enc} on the message M1 to obtain a random number Ra'. The random number Ra' is represented by the following formula (4). The cryptographic operation performed in the R/W apparatus 1 using the key K_{enc} is decryption processing.

[Math. 4]

$$\text{Ra'} = {\text{DEC}}_{{\text{K}}_{\text{enc}}} \left(\text{M1}\right)$$

In step S7, the R/W apparatus 1 performs authentication by comparing the random number Ra generated in step S1 with the random number Ra' obtained by decrypting the message M1 in step S6.

In a case where the random number Ra and the random number Ra' match, subsequent processing is performed with successful authentication. However, in a case where the two do not match, subsequent processing is performed with failed authentication.

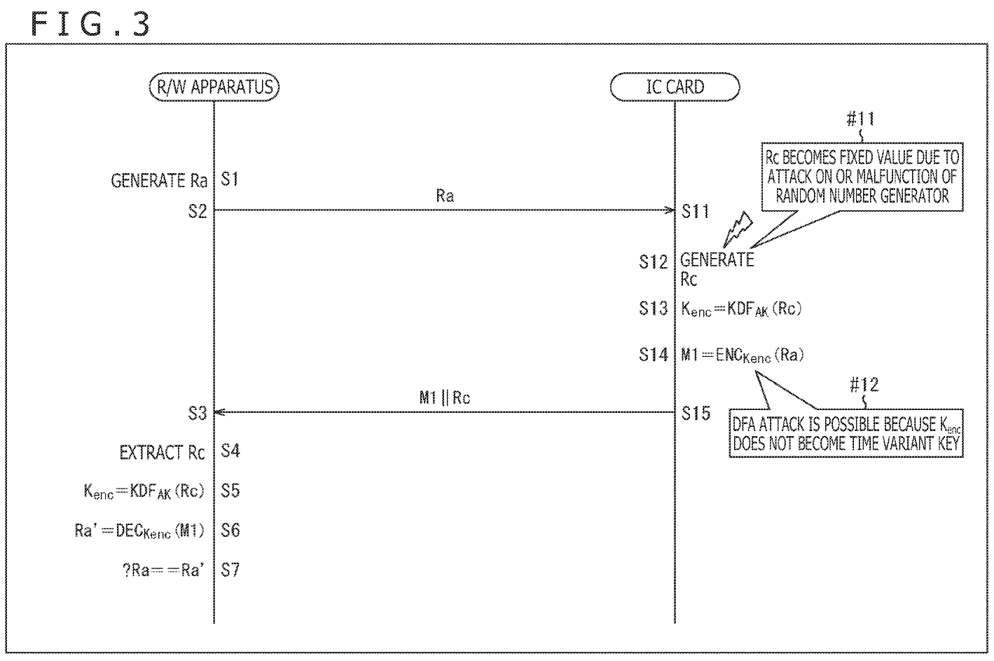

FIG. 3 is a view illustrating an example of wrongdoing.

As indicated by a speech balloon #11 in FIG. 3, the random number Rc may become a fixed value due to an attack on the random number generator which is provided on the IC card 2 and is for generating the random number Rc, or due to a malfunction of the random number generator. Note that the sequence illustrated in FIG. 3 is the same sequence as the sequence illustrated in FIG. 2.

In this case, because generation is performed on the basis of a fixed value, the key K_{enc} generated in the IC card 2 does not become a time variant key as indicated by a speech balloon #12. In other words, a state is entered in which a DFA attack using the message M1 is possible.

### Authentication Sequence According to an Embodiment of the Present Technique

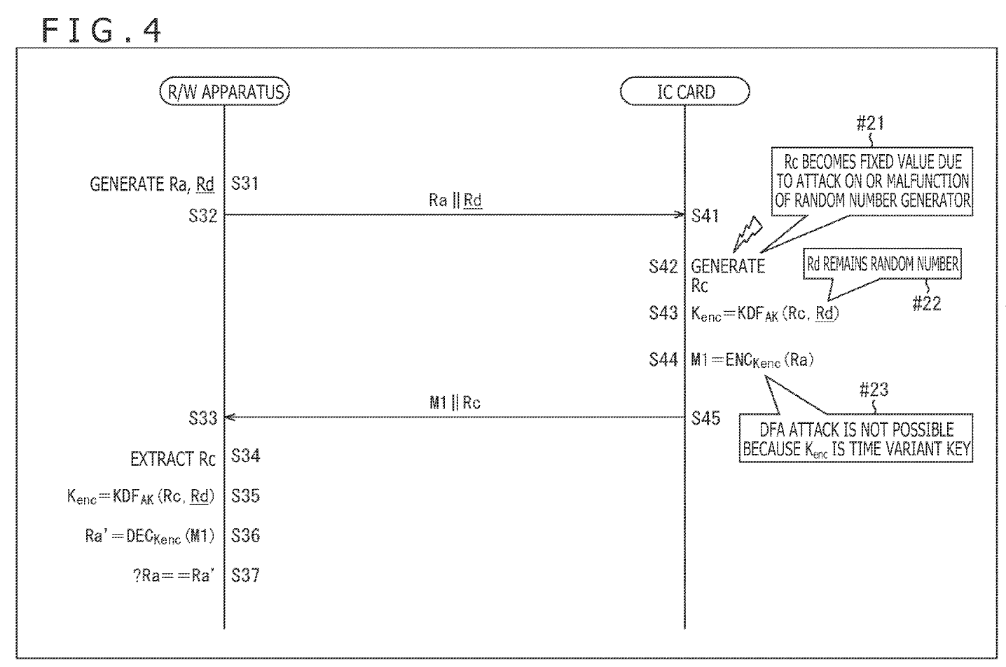

FIG. 4 is a view illustrating an example of an authentication sequence according to an embodiment of the present technique. Description which duplicates the description given above is omitted, as appropriate.

In the authentication sequence illustrated in FIG. 4, a random number Rd as well as the random number Rc are used to generate the key K_{enc}. As a result, the properties of the key K_{enc} as a time variant key are maintained.

In step S31, the R/W apparatus 1 generates a random number Ra and a random number Rd. The R/W apparatus 1 is provided with a random number generator for generating the random number Ra and a random number generator for generating the random number Rd.

In step S32, the R/W apparatus 1 joins and transmits the random number Ra and the random number Rd to the IC card 2.

In step S41, the IC card 2 receives the random number Ra and the random number Rd transmitted from the R/W apparatus 1.

In step S42, the IC card 2 generates the random number Rc.

In step S43, the IC card 2 generates the key K_{enc} by causing the key AK to act on the random number Rc generated in step S42 and the random number Rd transmitted from the R/W apparatus 1. The key K_{enc} is represented by the following formula (5).

[Math. 5]

$${\text{K}}_{\text{enc}} = {\text{KDF}}_{\text{AK}} \left(\text{Rc,Rd}\right)$$

In step S44, the IC card 2 performs encryption using the key K_{enc} on the random number Ra transmitted from the R/W apparatus 1 in order to generate a message M1.

In this manner, generation of the key K_{enc} is performed in the IC card 2 by using a combination of the random number Rc generated by the IC card 2 itself and the random number Rd generated by the R/W apparatus 1.

Accordingly, even in the case where the random number Rc has become a fixed value due to, for example, an attack on the random number generator as indicated in a speech balloon #21, the random number Rd remains a random number as indicated by a speech balloon #22. The key K_{enc}, which is generated using the random number Rd, becomes a time variant key.

In addition, because the key used to generate the message M1 is a time variant key, a state in which a DFA attack using the message M1 is not possible is entered, as indicated in a speech balloon #23.

In step S45, the IC card 2 joins and transmits the message M1 and the random number Rc.

In step S33, the R/W apparatus 1 receives the message M1 and the random number Rc transmitted from the IC card 2.

In step S34, the R/W apparatus 1 extracts the random number Rc from the received information.

In step S35, the R/W apparatus 1 generates the key K_{enc} by causing the key AK to act on the random number Rc extracted in step S34 and the random number Rd generated in step S31. The key K_{enc} is represented by the above formula (5).

In the R/W apparatus 1, generation of the key K_{enc} is performed by using a combination of the random number Rc generated by the IC card 2 and the random number Rd generated by the R/W apparatus 1 itself.

In step S36, the R/W apparatus 1 performs a cryptographic operation using the key K_{enc} on the message M1 to decrypt a random number Ra'.

In step S37, the R/W apparatus 1 performs authentication by comparing the random number Ra generated in step S31 with the random number Ra' obtained by decrypting the message M1 in step S36.

In a case where the random number Ra and the random number Ra' match, subsequent processing is performed with successful authentication. However, in a case where the two do not match, subsequent processing is performed with failed authentication.

In this manner, between the R/W apparatus 1 and the IC card 2, the key K_{enc} is generated by using random numbers respectively generated by the two.

As a result, even if the random number Rc has become a fixed value due to, for example, an attack on the random number generator in the IC card 2, it is possible to prevent a reduction of the randomness of random numbers used to generate the key K_{enc}. Because generation of the key K_{enc} is performed on the basis of a random number, as a result, it is possible to improve the safety of the key K_{enc}, which is a time variant key.

### Effect of Authentication Sequence According to an Embodiment of the Present Technique

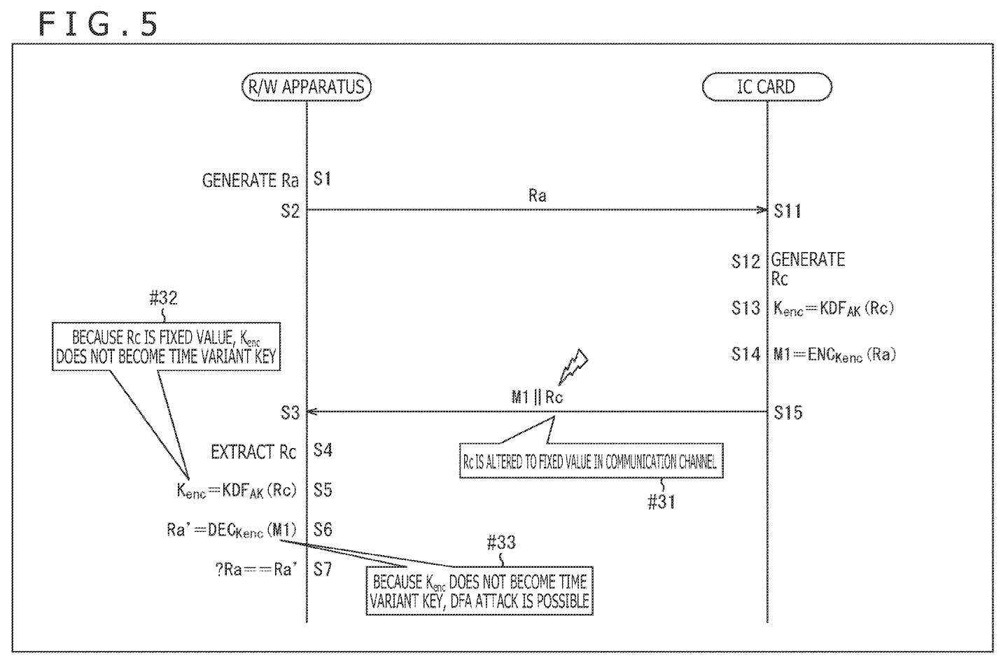

FIG. 5 is a view illustrating another example of wrongdoing.

As indicated by a speech balloon #31 in FIG. 5, the random number Rc generated by the IC card 2 may be altered to a fixed value on a communication channel. The sequence illustrated in FIG. 5 is the same sequence as the sequence illustrated in FIG. 2.

In this case, because generation is performed on the basis of a fixed value, the key K_{enc} generated in the R/W apparatus 1 does not become a time variant key as indicated by a speech balloon #32. In other words, a state is entered in which a DFA attack using the message M1 is possible, as indicated by a speech balloon #33.

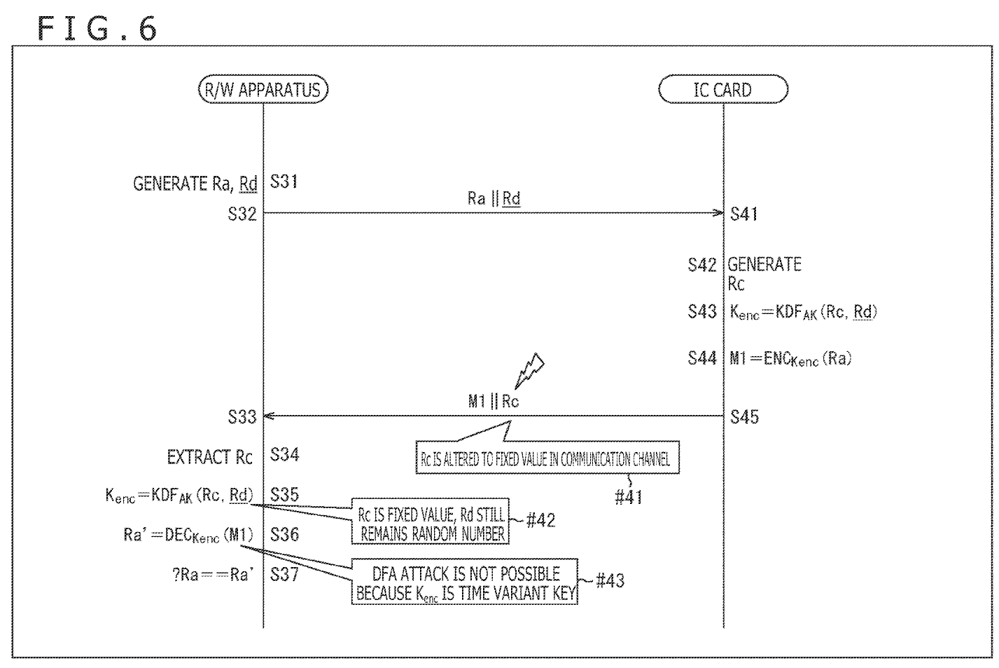

FIG. 6 is a view for giving a description regarding an effect realized by the authentication sequence in FIG. 4.

The sequence illustrated in FIG. 6 is the same sequence as the sequence described with reference to FIG. 4. Even in a case where the random number Rc generated by the IC card 2 is altered to a fixed value in a communication channel as indicated by a speech balloon #41 in FIG. 6, the random number Rd remains a random number as indicated by a speech balloon #42. The key K_{enc}, which is generated using the random number Rd, becomes a time variant key.

In addition, because the key used to decrypt the message M1 is a time variant key, a state in which a DFA attack using the message M1 is not possible is entered, as indicated in a speech balloon #43.

In this manner, even in a case where the random number Rc generated by the IC card 2 is altered to a fixed value in a communication channel, it is possible to improve the safety of the key K_{enc} which is a time variant key.

### Application Examples

Description is given regarding application examples for the authentication sequence using the key K_{enc} generated on the basis of the random numbers Rc and Rd.

### Application Example 1 (MAC One-Way Authentication)

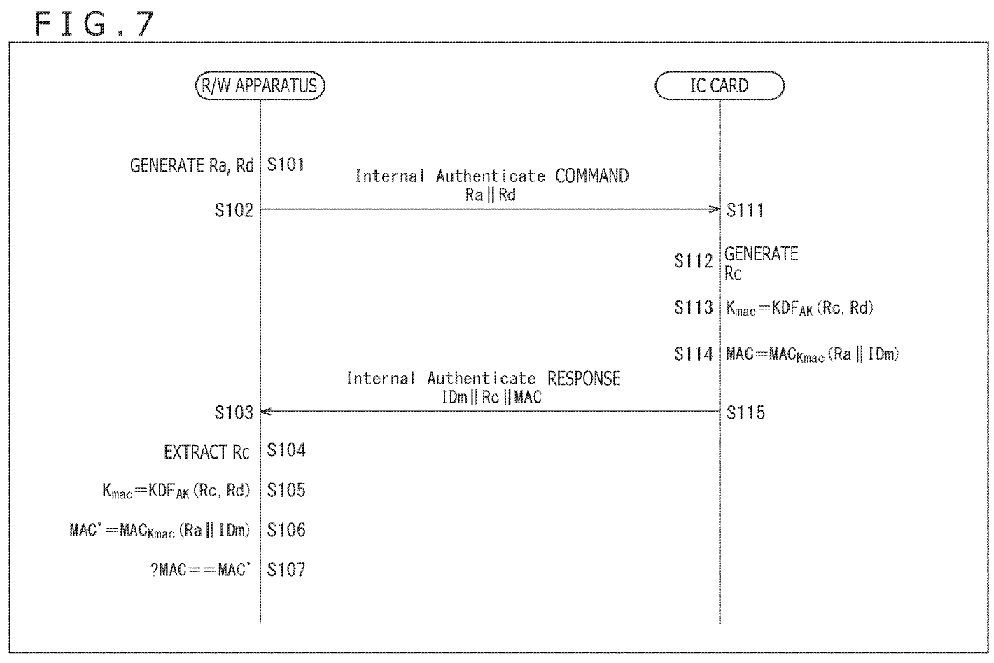

FIG. 7 is a view illustrating a sequence in a case of performing MAC one-way authentication.

In MAC authentication, a MAC is generated using IDm which is identification information for an IC chip in the IC card 2. In addition, using the MAC, verification is performed as to whether or not an unauthorized alteration, etc., has been performed. For FIG. 7, description which duplicates the description given above is omitted, as appropriate.

In step S101, the R/W apparatus 1 generates a random number Ra and a random number Rd.

In step S102, the R/W apparatus 1 transmits an Internal Authenticate command as well as the random number Ra and the random number Rd to the IC card 2 after joining the random number Ra and the random number Rd.

In step S111, the IC card 2 receives the Internal Authenticate command, the random number Ra, and the random number Rd which are transmitted from the R/W apparatus 1.

In step S112, the IC card 2 generates a random number Rc.

In step S113, the IC card 2 generates a key (MAC key) K_{mac} by causing the key AK to act on the random number Rc generated in step S112 and the random number Rd transmitted from the R/W apparatus 1. The key K_{mac} is represented by the following formula (6).

[Math. 6]

$${\text{K}}_{\text{mac}} = {\text{KDF}}_{\text{AK}} \left(\text{Rc, Rd}\right)$$

In this manner, generation of the key K_{mac} is performed in the IC card 2 by using a combination of the random number Rc generated by the IC card 2 itself and the random number Rd generated by the R/W apparatus 1.

In step S114, the IC card 2 generates a MAC by performing a cryptographic calculation using the key K_{mac} on data resulting from joining the random number Ra transmitted from the R/W apparatus 1 with the IDm for the IC card 2. The MAC is represented by the following formula (7).

[Math. 7]

$${\text{MAC=MAC}}_{\text{Kmac}} \left(\left(\text{Ra}\right‖ \text{I} \text{} \text{} \text{} \text{} \text{} \text{Dm}\right)$$

In step S115, the IC card 2 transmits an Internal Authenticate response as well as the IDm, the random number Rc, and the MAC after joining the IDm, the random number Rc, and the MAC.

In step S103, the R/W apparatus 1 receives the IDm, the random number Rc, and the MAC which are transmitted from the IC card 2.

In step S104, the R/W apparatus 1 extracts the random number Rc from the received information.

In step S105, the R/W apparatus 1 generates a key K_{mac} by causing the key AK to act on the random number Rc extracted in step S104 and the random number Rd generated in step S101. The key K_{mac} is represented by the above formula (6).

In the R/W apparatus 1, generation of the key K_{mac} is performed by using a combination of the random number Rc generated by the IC card 2 and the random number Rd generated by the R/W apparatus 1 itself.

In step S106, the R/W apparatus 1 generates a MAC' by performing a cryptographic calculation using the key K_{mac} on data resulting from joining the random number Ra transmitted from the IC card 2 with the IDm. The MAC' is represented by the following formula (8).

[Math. 8]

$${\text{MA} {\text{C}}^{′} \text{=MAC}}_{\text{Kmac}} \left(\left(\text{Ra}\right‖ \text{I} \text{} \text{} \text{} \text{} \text{} \text{Dm}\right)$$

In step S107, the R/W apparatus 1 performs authentication by comparing the MAC received in step S103 with the MAC' generated in step S106.

In a case where the MAC and the MAC' match, subsequent processing is performed with successful authentication. However, in a case where the two do not match, subsequent processing is performed with failed authentication.

By MAC one-way authentication being performed in the above manner, even in the case where the random number Rc has become a fixed value due to, for example, an attack on the random number generator in the IC card 2, it is possible to improve the safety of the key K_{mac} which is a time variant key.

### Application Example 2 (MAC Mutual Authentication)

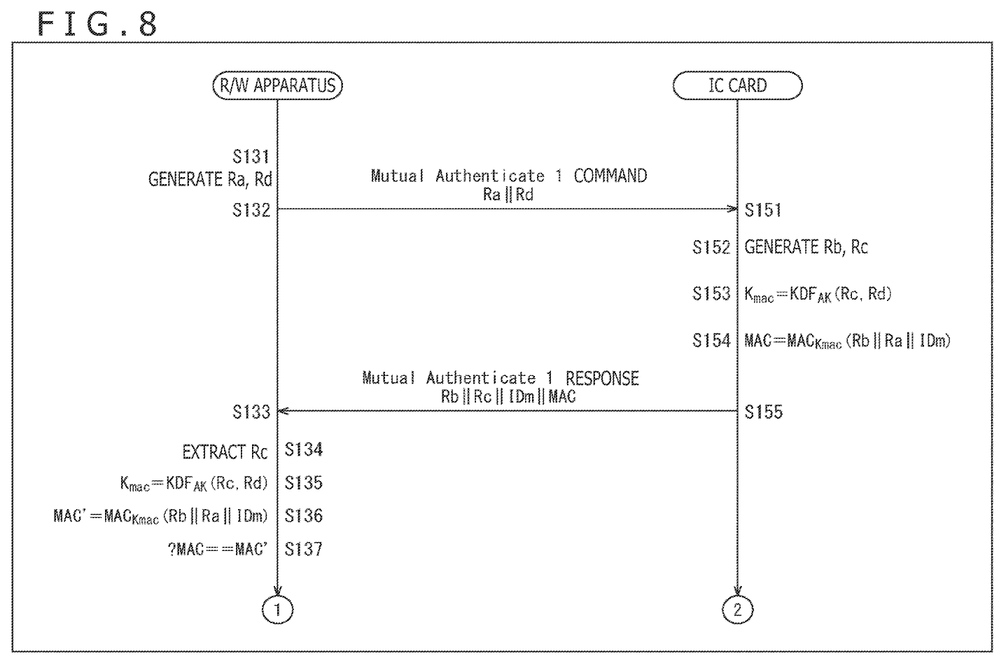

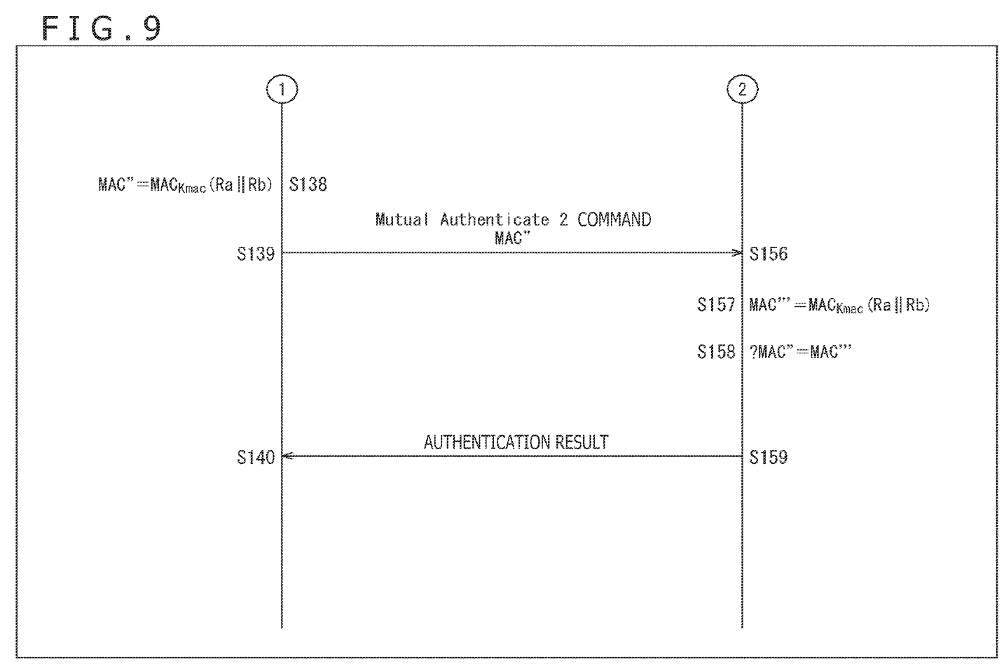

FIG. 8 and FIG. 9 are views illustrating a sequence in a case of performing MAC mutual authentication. For FIG. 8 and FIG. 9, description which duplicates the description given above is omitted, as appropriate.

In step S131, the R/W apparatus 1 generates a random number Ra and a random number Rd.

In step S132, the R/W apparatus 1 transmits a Mutual Authenticate 1 command as well as the random number Ra and the random number Rd to the IC card 2 after joining the random number Ra and the random number Rd.

In step S151, the IC card 2 receives the Mutual Authenticate 1 command, the random number Ra, and the random number Rd which are transmitted from the R/W apparatus 1.

In step S152, the IC card 2 generates a random number Rb and a random number Rc.

In step S153, the IC card 2 generates a key K_{mac} by causing the key AK to act on the random number Rc generated in step S152 and the random number Rd transmitted from the R/W apparatus 1. The key K_{mac} is represented by the above formula (6).

In step S154, the IC card 2 generates a MAC by performing a cryptographic calculation using the key K_{mac} on data resulting from joining the random number Rb, the random number Ra transmitted from the R/W apparatus 1, and the IDm. The MAC is represented by the following formula (9).

[Math. 9]

$${\text{MAC=MAC}}_{\text{Kmac}} \left(\text{Rb} \left‖\text{Ra}\right‖ \text{I} \text{} \text{} \text{} \text{} \text{} \text{Dm}\right)$$

In step S155, the IC card 2 transmits a Mutual Authenticate 1 response as well as the random number Rb, the random number Rc, the IDm, and the MAC after joining the random number Rb, the random number Rc, the IDm, and the MAC.

In step S133, the R/W apparatus 1 receives the random number Rb, the random number Rc, the IDm, and the MAC which are transmitted from the IC card 2.

In step S134, the R/W apparatus 1 extracts the random number Rc from the received information.

In step S135, the R/W apparatus 1 generates a key K_{mac} by causing the key AK to act on the random number Rc extracted in step S104 and the random number Rd generated in step S131. The key K_{mac} is represented by the above formula (6).

In step S136, the R/W apparatus 1 generates a MAC' by performing cryptographic processing using the key K_{mac} on data resulting from joining the random number Rb, the random number Ra, and the IDm. The MAC' is represented by the following formula (10).

[Math. 10]

$${\text{MAC' = MAC}}_{\text{Kmac}} \left(\text{Rb} \left‖\text{Ra}\right‖ \text{I} \text{} \text{} \text{} \text{} \text{} \text{Dm}\right)$$

In step S137, the R/W apparatus 1 performs authentication by comparing the MAC received in step S133 with the MAC' generated in step S136.

In a case where the MAC and the MAC' match, in step S138 (FIG. 9), the R/W apparatus 1 generates a MAC" by performing a cryptographic operation using the key K_{mac} on data resulting from joining the random number Ra generated in step S131 and the random number Rb transmitted from the IC card 2. The MAC" is represented by the following formula (11).

[Math. 11]

$${\text{MAC" = MAC}}_{\text{Kmac}} \left(\text{Ra} \text{\textbar} \text{\textbar} \text{Rb}\right)$$

In step S139, the R/W apparatus 1 transmits a Mutual Authenticate 2 command as well as the MAC" generated in step S138 to the IC card 2.

In step S156, the IC card 2 receives the Mutual Authenticate 2 command and the MAC" which are transmitted from the R/W apparatus 1.

In step S157, the IC card 2 generates a MAC"' by performing a cryptographic operation using the key K_{mac} on data resulting from joining the random number Ra transmitted from the R/W apparatus 1 and the random number Rb generated in step S152. The MAC"' is represented by the following formula (12).

[Math. 12]

$${\text{MAC'" = MAC}}_{\text{Kmac}} \left(\text{Ra} \text{\textbar} \text{\textbar} \text{Rb}\right)$$

In step S158, the IC card 2 performs authentication by comparing the MAC" received in step S156 with the MAC"' generated in step S157.

In step S159, the IC card 2 transmits an authentication result for the MAC" and the MAC"'.

In step S140, the R/W apparatus 1 receives the authentication result transmitted from the IC card 2.

By the above processing, it is possible to realize MAC mutual authentication for which a DFA attack is more difficult.

### Application Example 3 (Combination of MAC Mutual Authentication and Reading and Writing of Data)

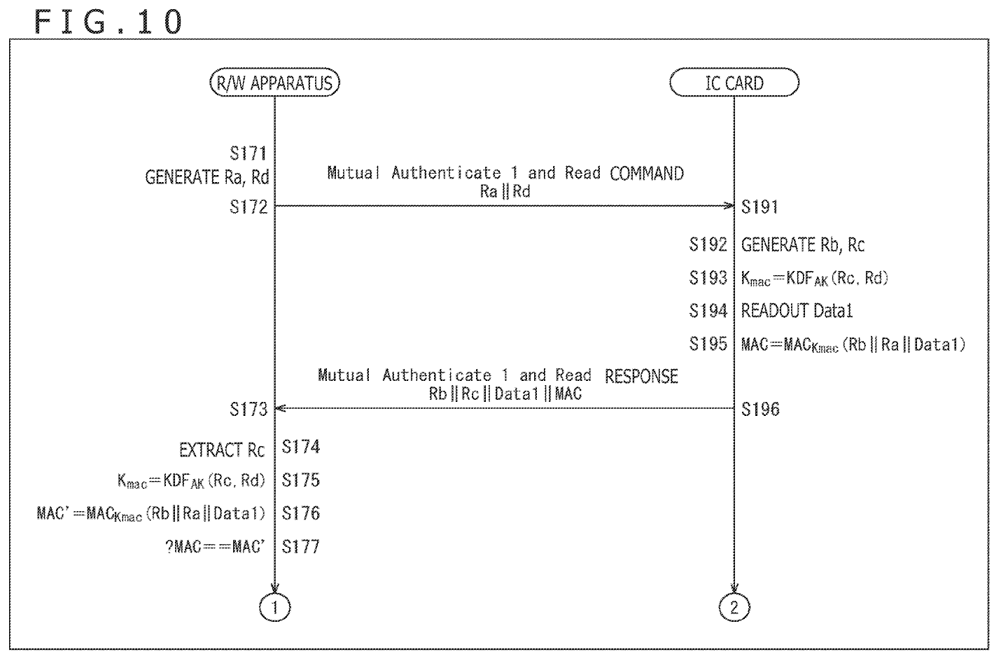

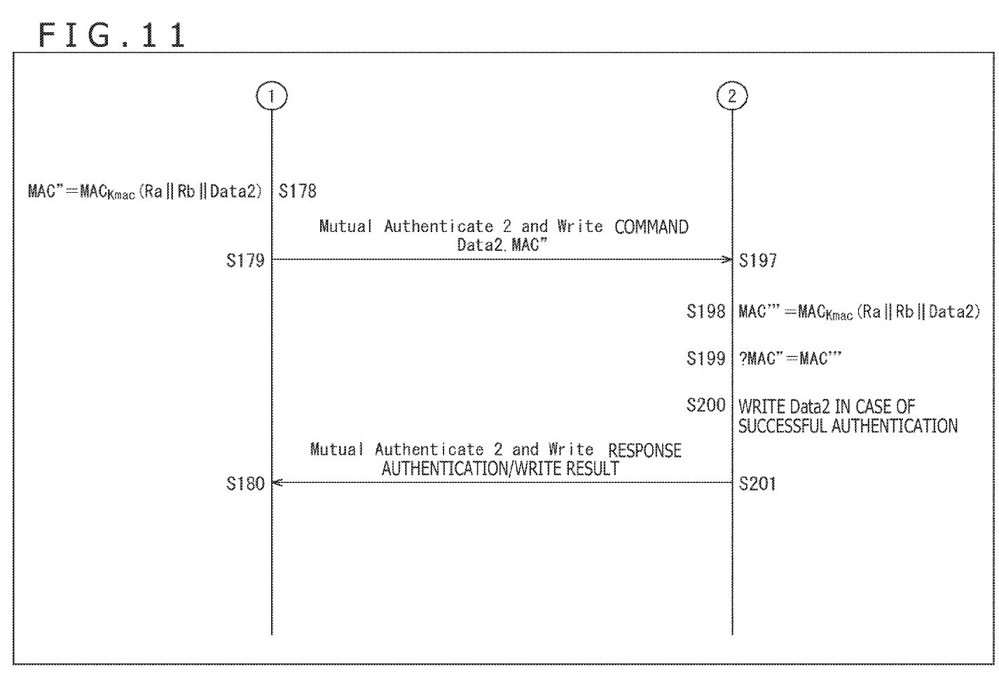

FIG. 10 and FIG. 11 are views illustrating a sequence in a case of performing MAC mutual authentication and reading and writing data.

By the processing in FIG. 10 and FIG. 11, reading and writing of data stored in the IC card 2 are performed together with MAC mutual authentication. For FIG. 10 and FIG. 11, description which duplicates the description given above is omitted, as appropriate.

In step S171, the R/W apparatus 1 generates a random number Ra and a random number Rd.

In step S172, the R/W apparatus 1 transmits a Mutual Authenticate 1 and Read command as well as the random number Ra and the random number Rd to the IC card 2 after joining the random number Ra and the random number Rd.

In step S191, the IC card 2 receives the Mutual Authenticate 1 and Read command, the random number Ra, and the random number Rd which are transmitted from the R/W apparatus 1.

In step S192, the IC card 2 generates a random number Rb and a random number Rc.

In step S193, the IC card 2 generates a key K_{mac} by causing the key AK to act on the random number Rc generated in step S192 and the random number Rd transmitted from the R/W apparatus 1. The key K_{mac} is represented by the above formula (6).

In step S194, the IC card 2 reads out Datal stored in a memory in the IC chip.

In step S195, the IC card 2 generates a MAC by performing a cryptographic operation using the key K_{mac} on data resulting from joining the random number Rb generated in step S192, the random number Ra transmitted from the R/W apparatus 1, and the Datal read out in step S194. The MAC is represented by the following formula (13).

[Math. 13]

$${\text{MAC = MAC}}_{\text{Kmac}} \left(\text{Rb} \text{\textbar} \text{\textbar} \text{Ra} \text{\textbar} \text{\textbar} \text{Data1}\right)$$

In step S196, the IC card 2 joins and transmits, as a Mutual Authenticate 2 and Read response, the random number Rb, the random number Rc, the Datal, and the MAC.

In step S173, the R/W apparatus 1 receives the random number Rb, the random number Rc, the Datal, and the MAC which are transmitted from the IC card 2.

In step S174, the R/W apparatus 1 extracts the random number Rc from the received information.

In step S175, the R/W apparatus 1 generates a key K_{mac} by causing the key AK to act on the random number Rc extracted in step S174 and the random number Rd generated in step S171. The key K_{mac} is represented by the above formula (6).

In step S176, the R/W apparatus 1 generates a MAC' by performing a cryptographic operation using the key K_{mac} on data resulting from joining the random number Rb, the random number Ra, and the Datal. The MAC' is represented by the following formula (14).

[Math. 14]

$${\text{MAC' = MAC}}_{\text{Kmac}} \left(\text{Rb} \text{\textbar} \text{\textbar} \text{Ra} \text{\textbar} \text{\textbar} \text{Data1}\right)$$

In step S177, the R/W apparatus 1 performs authentication by comparing the MAC received in step S173 with the MAC' generated in step S176.

In a case where the MAC and the MAC' match, in step S178 (FIG. 11), the R/W apparatus 1 generates a MAC" by performing a cryptographic operation using the key K_{mac} on data resulting from joining the random number Ra, the random number Rb, and Data2. The MAC" is represented by the following formula (15).

[Math. 15]

$${\text{MAC" = MAC}}_{\text{Kmac}} \left(\text{Ra} \text{\textbar} \text{\textbar} \text{Rb} \text{\textbar} \text{\textbar} \text{Data2}\right)$$

In step S179, the R/W apparatus 1 transmits a Mutual Authenticate 2 and Write command as well as the Data2 and the MAC" to the IC card 2. The Data2 is data which is to be caused to be newly stored in the memory in the IC chip.

In step S197, the IC card 2 receives the Mutual Authenticate 2 and Write command, the Data2, and the MAC" which are transmitted from the R/W apparatus 1.

In step S198, the IC card 2 generates a MAC"' by performing a cryptographic operation using the key K_{mac} on data resulting from joining the random number Ra, the random number Rb, and the Data2. The MAC"' is represented by the following formula (16).

[Math. 16]

$$\text{MAC'"} = {\text{MAC}}_{\text{Kmac}} \left(\text{Ra} \text{\textbar} \text{\textbar} \text{Rb} \text{\textbar} \text{\textbar} \text{Data2}\right)$$

In step S199, the IC card 2 performs authentication by comparing the MAC" received in step S197 with the MAC"' generated in step S198.

In step S200, the IC card 2 writes the Data2 in a case where the MAC" and the MAC"' match and authentication succeeded.

In step S201, the IC card 2 transmits an authentication result and a write result as a Mutual Authenticate 2 and Write response.

In step S180, the R/W apparatus 1 receives the authentication result and the write result which are transmitted from the IC card 2.

### Application Example 4 (Combination of Encrypted MAC Mutual Authentication and Reading and Writing of Encrypted Data)

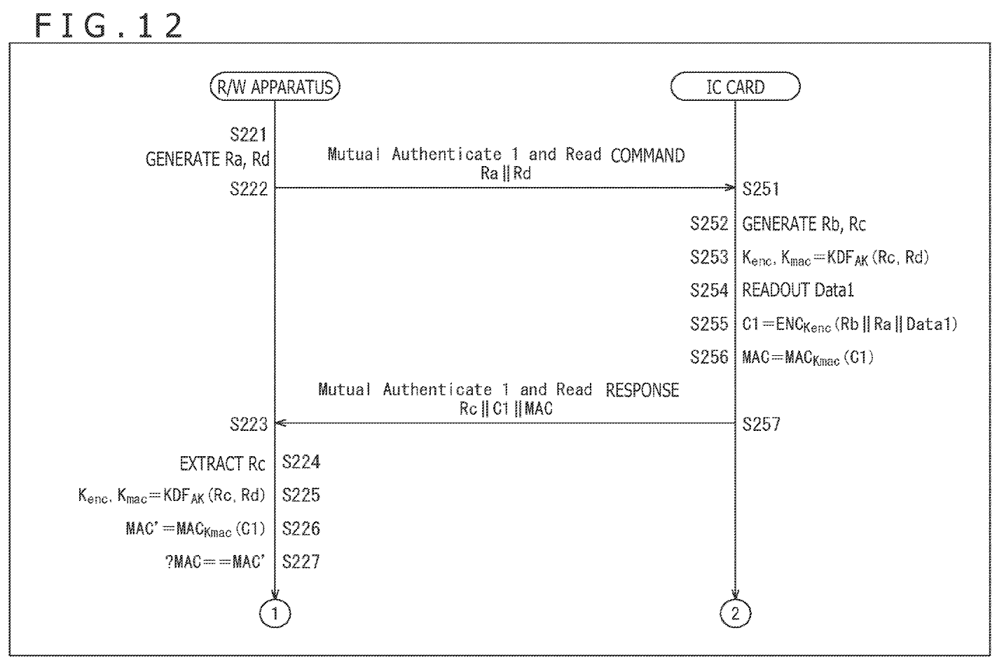

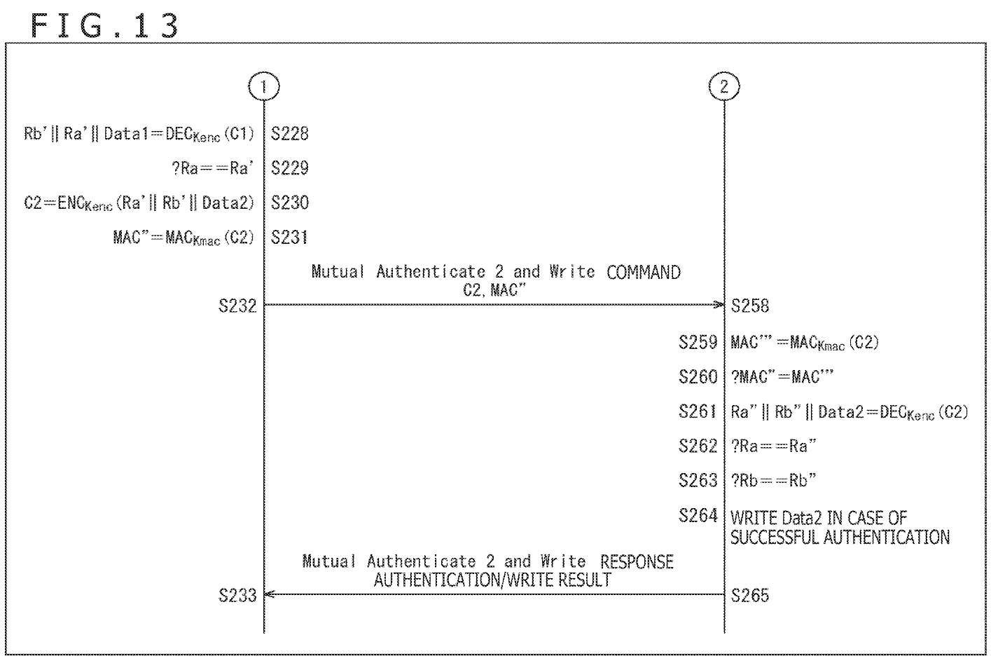

FIG. 12 and FIG. 13 are views illustrating a sequence in a case of performing MAC mutual authentication and reading and writing encrypted data.

The processing in FIG. 12 and FIG. 13 differs from the processing in FIG. 10 and FIG. 11 in that the transmission and reception of data read out from the IC card 2 and the transmission and reception of data written to the IC card 2 are performed in encrypted states. For FIG. 12 and FIG. 13, description which duplicates the description given above is omitted, as appropriate.

In step S221, the R/W apparatus 1 generates a random number Ra and a random number Rd.

In step S222, the R/W apparatus 1 transmits a Mutual Authenticate 1 and Read command as well as the random number Ra and the random number Rd to the IC card 2 after joining the random number Ra and the random number Rd.

In step S251, the IC card 2 receives the Mutual Authenticate 1 and Read command, the random number Ra, and the random number Rd which are transmitted from the R/W apparatus 1.

In step S252, the IC card 2 generates a random number Rb and a random number Rc.

In step S253, the IC card 2 generates the key Kenc and the key K_{mac} by causing the key AK to act on the random number Rc generated in step S252 and the random number Rd transmitted from the R/W apparatus 1. The key K_{enc} and the key K_{mac} are represented by the following formula (17).

[Math. 17]

$${\text{K}}_{\text{enc}} , {\text{K}}_{\text{mac}} = {\text{KDF}}_{\text{AK}} \left(\text{Rc} \text{\textbar} \text{\textbar} \text{Rd}\right)$$

In step S254, the IC card 2 reads out Datal stored in a memory in the IC chip.

In step S255, the IC card 2 generates a cipher text C1 by performing a cryptographic operation using the key K_{enc} on data resulting from joining the random number Rb generated in step S252, the random number Ra transmitted from the R/W apparatus 1, and the Datal read out in step S254. The cipher text C1 is represented by the following formula (18).

[Math. 18]

$$\text{C1} = {\text{ENC}}_{\text{Kenc}} \left(\text{Rb} \text{\textbar} \text{\textbar} \text{Ra} \text{\textbar} \text{\textbar} \text{Data1}\right)$$

In step S256, the IC card 2 generates a MAC by performing a cryptographic operation using the key K_{mac} on the cipher text C1 generated in step S255. The MAC is represented by the following formula (19).

[Math. 19]

$$\text{MAC} = {\text{MAC}}_{\text{Kmac}} \left(\text{C1}\right)$$

In step S257, the IC card 2 joins and transmits, as a Mutual Authenticate 2 and Read response, the random number Rc, the cipher text C1, and the MAC.

In step S223, the R/W apparatus 1 receives the random number Rc, the cipher text C1, and the MAC which are transmitted from the IC card 2.

In step S224, the R/W apparatus 1 extracts the random number Rc from the received information.

In step S225, the R/W apparatus 1 generates the key K_{enc} and key K_{mac} by causing the key AK to act on the random number Rc extracted in step S224 and the random number Rd generated in step S221. The key K_{enc} and the key K_{mac} are represented by the above formula (17).

In step S226, the R/W apparatus 1 generates a MAC' by performing a cryptographic operation using the key K_{mac} on the cipher text C1 transmitted from the IC card 2. The MAC' is represented by the following formula (20).

[Math. 20]

$$\text{MAC'} = {\text{MAC}}_{\text{Kmac}} \left(\text{C1}\right)$$

In step S227, the R/W apparatus 1 performs authentication by comparing the MAC received in step S223 with the MAC' generated in step S226.

In a case where the MAC and the MAC' match, in step S228 (FIG. 13), the R/W apparatus 1 performs a cryptographic operation using the key K_{enc} on the cipher text C1 transmitted from the IC card 2, to thereby decrypt a random number Rb', a random number Ra', and Datal. The decrypted random number Rb', random number Ra', and Datal are represented by the following formula (21) .

[Math. 21]

$$\left(\text{Rb'}\right| \left|\text{Ra'}\right| \left|\text{Data1}\right) = {\text{DEC}}_{\text{Kenc}} \left(\text{C1}\right)$$

In step S229, the R/W apparatus 1 compares the random number Ra generated in step S221 with the random number Ra' obtained by being decrypted in step S228.

In a case where the random number Ra and the random number Ra' match, in step S230, the R/W apparatus 1 generates a cipher text C2 by performing a cryptographic operation using the key K_{enc} on data resulting from joining the random number Ra', the random number Rb', and the Data2. The cipher text C2 is represented by the following formula (22).

[Math. 22]

$${\text{C2 = ENC}}_{\text{Kenc}} \left(\left(\text{Ra'}\right| \left|\text{Rb'}\right| \left|\text{Data2}\right) \text{}\right)$$

In step S231, the R/W apparatus 1 generates a MAC" by performing a cryptographic operation using the key K_{mac} on the cipher text C2 generated in step S230. The MAC" is represented by the following formula (23).

[Math. 23]

$${\text{MAC" = MAC}}_{\text{Kmac}} \left(\text{C2}\right)$$

In step S232, the R/W apparatus 1 transmits a Mutual Authenticate 2 and Write command as well as the cipher text C2 and the MAC" to the IC card 2.

In step S258, the IC card 2 receives the Mutual Authenticate 2 and Write command, the cipher text C2, and the MAC" which are transmitted from the R/W apparatus 1.

In step S259, the IC card 2 generates a MAC"' by performing a cryptographic operation using the key K_{mac} on the cipher text C2 received in step S258. The MAC"' is represented by the following formula (24).

[Math. 24]

$${\text{MAC''' = MAC}}_{\text{Kmac}} \left(\text{C2}\right)$$

In step S260, the IC card 2 performs authentication by comparing the MAC" received in step S258 with the MAC"' generated in step S259.

In a case where the MAC" and the MAC"' match, in step S261, the IC card 2 performs a cryptographic operation using the key K_{enc} on the cipher text C2 transmitted from the R/W apparatus 1, to thereby decrypt a random number Ra", a random number Rb", and Data2. The decrypted random number Ra", random number Rb", and Data2 are represented by the following formula (25).

[Math. 25]

$$\text{Ra"} \left‖\text{Rb"}\right‖ {\text{Data2 = DEC}}_{\text{Kenc}} \left(\text{C2}\right)$$

In step S262, the IC card 2 compares the random number Ra received in step S251 with the random number Ra" obtained by being decrypted in step S261.

In a case where the random number Ra and the random number Ra" match, in step S263, the IC card 2 compares the random number Rb generated in step S252 with the random number Rb" obtained by being decrypted in step S261.

In the case where the random number Rb and the random number Rb" match, in step S264, the IC card 2 writes Data2.

In step S265, the IC card 2 transmits an authentication result and a write result as a Mutual Authenticate 2 and Write response.

In step S233, the R/W apparatus 1 receives the authentication result and the write result transmitted from the IC card 2.

### Apparatus Configurations

Description is given here regarding configurations of the R/W apparatus 1 and the IC card 2.

### Configuration of IC Card 2

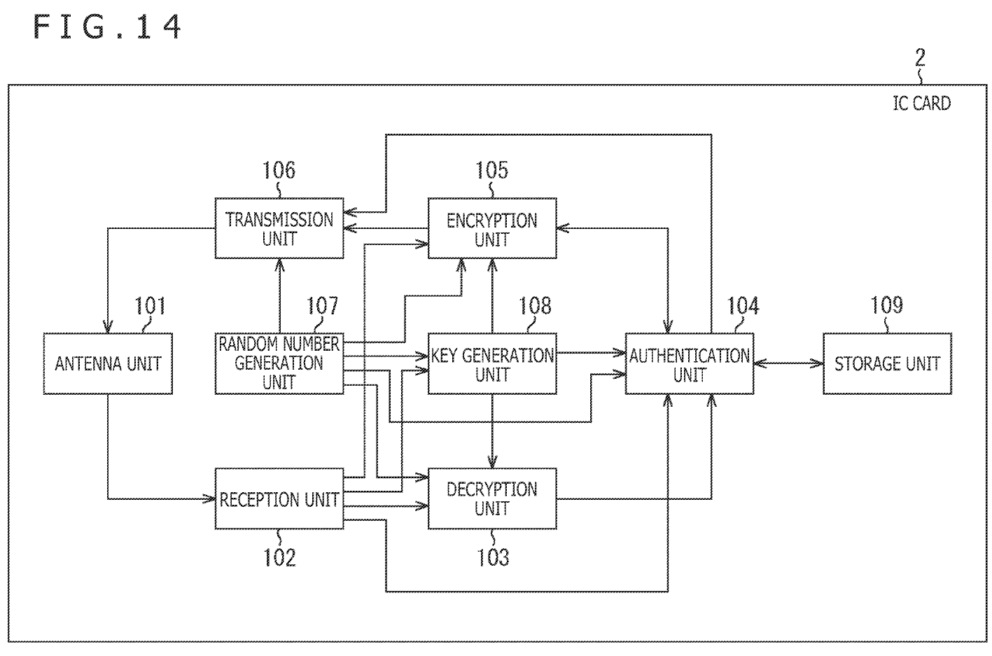

FIG. 14 is a block view illustrating an example of a configuration of the IC card 2.

The IC card 2 includes an antenna unit 101, a reception unit 102, a decryption unit 103, an authentication unit 104, an encryption unit 105, a transmission unit 106, a random number generation unit 107, a key generation unit 108, and a storage unit 109.

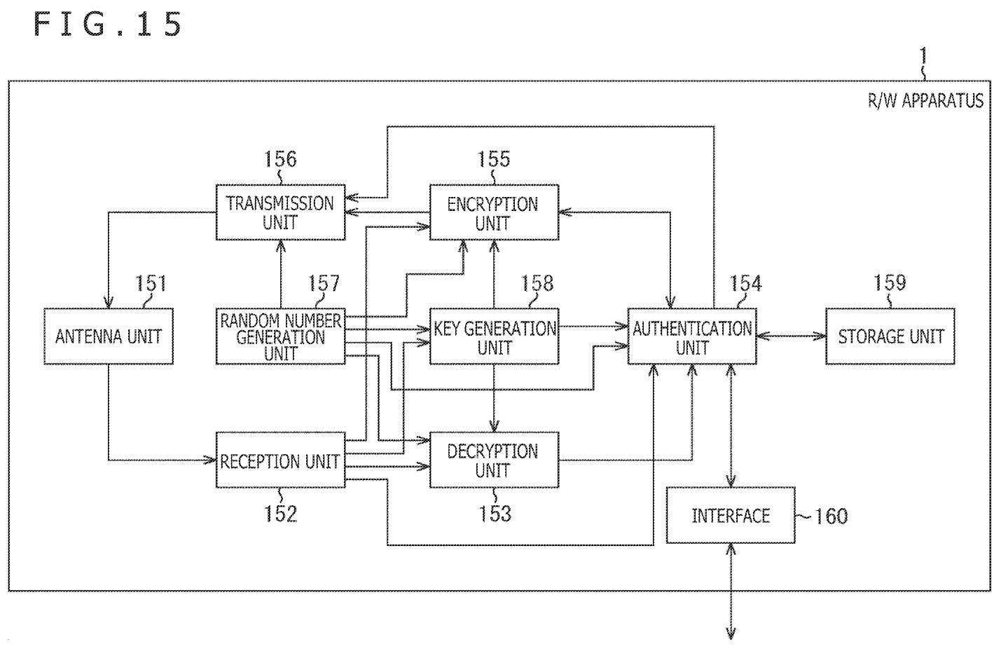

In a case where the IC card 2 functions as an information processing apparatus, the antenna unit 101 transmits and receives electromagnetic waves to and from an antenna unit 151 (FIG. 15) in the R/W apparatus 1 which functions as another information processing apparatus.

The reception unit 102, via the antenna unit 101, receives and demodulates a signal transmitted from the R/W apparatus 1.

The decryption unit 103 decrypts encrypted information received by the reception unit 102.

The authentication unit 104 performs authentication processing for the R/W apparatus 1, on the basis of information supplied from the decryption unit 103, for example. The authentication processing, which is performed on the basis of a message M1 generated by encryption using a time variant key, is controlled by the authentication unit 104. In addition, authentication processing that is performed on the basis of a MAC which is a message generated by encrypting data including the IDm using a time variant key is controlled by the authentication unit 104.

In addition, in a case where authentication processing is successful, the authentication unit 104 reads out data stored in the storage unit 109 or writes data to the storage unit 109.

The encryption unit 105 performs a cryptographic operation on information to be transmitted to the R/W apparatus 1. Encryption of the data is performed by the cryptographic operation by the encryption unit 105.

The transmission unit 106 modulates information supplied from the encryption unit 105, for example, and causes the modulated information to be transmitted to the R/W apparatus 1 by being outputted to the antenna unit 101.

The random number generation unit 107 generates a random number. The random number generation unit 107 functions as the random number generator described above. A random number generated by the random number generation unit 107 does not need to be a random number in a mathematical sense, and may be pseudo-random number or a counter value generated by a counter.

The key generation unit 108 generates a time variant key on the basis of information supplied from the random number generation unit 107, for example, and supplies the time variant key to the decryption unit 103 and the encryption unit 105. The time variant key is a key that changes each time it is generated.

The storage unit 109 includes a memory in the IC chip. The storage unit 109 stores various types of information such as a program to be executed in the IC chip, an IDm, or information pertaining to electronic money.

An output from the reception unit 102 is supplied to, for example, the authentication unit 104, the encryption unit 105, and the key generation unit 108, in addition to the decryption unit 103. An output from the authentication unit 104 is supplied to, for example, the transmission unit 106 in addition to the encryption unit 105. An output from the random number generation unit 107 is supplied to, for example, the decryption unit 103, the authentication unit 104, the encryption unit 105, and the transmission unit 106, in addition to the key generation unit 108. An output from the key generation unit 108 is supplied to the authentication unit 104 in addition to the decryption unit 103 and the encryption unit 105.

For example, from among the processing in the steps included in the authentication sequence in FIG. 4, the processing in step S41 is performed by the reception unit 102. The processing in step S42 is performed by the random number generation unit 107, and the processing in step S43 is performed by the key generation unit 108. The processing in step S44 is performed by the encryption unit 105, and the processing in step S45 is performed by the transmission unit 106.

In addition, from among the processing in the steps included in the authentication sequence in FIG. 7, the processing in step S111 is performed by the reception unit 102. The processing in step S112 is performed by the random number generation unit 107, and the processing in step S113 is performed by the key generation unit 108. The processing in step S114 is performed by the encryption unit 105, and the processing in step S115 is performed by the transmission unit 106.

In addition, from among the processing in the steps included in the authentication sequence in FIG. 8 and FIG. 9, the processing in step S151 and step S156 is performed by the reception unit 102. The processing in step S152 is performed by the random number generation unit 107, and the processing in step S153 is performed by the key generation unit 108. The processing in step S154 and step S157 is performed by the encryption unit 105, and the processing in step S155 and step S159 is performed by the transmission unit 106. The processing in step S158 is performed by the authentication unit 104.

The processing in each step for the IC card 2 included in the authentication sequences in FIG. 10 and subsequent figures is similarly performed by the corresponding unit in the IC card 2.

### Configuration of R/W Apparatus 1

FIG. 15 is a block view illustrating an example of a configuration of the R/W apparatus 1.

The R/W apparatus 1 includes the antenna unit 151, a reception unit 152, a decryption unit 153, an authentication unit 154, an encryption unit 155, a transmission unit 156, a random number generation unit 157, a key generation unit 158, a storage unit 159, and an interface 160. The R/W apparatus 1 has a configuration which is similar to the configuration of the IC card 2. Duplicate description is omitted, as appropriate.

In a case where the R/W apparatus 1 functions as an information processing apparatus, the antenna unit 151 transmits and receives electromagnetic waves to and from the antenna unit 101 in the IC card 2 which functions as another information processing apparatus.

The reception unit 152, via the antenna unit 151, receives and demodulates a signal transmitted from the IC card 2.

The decryption unit 153 decrypts encrypted information received by the reception unit 152.

The authentication unit 154 performs authentication processing for the IC card 2, on the basis of information supplied from the decryption unit 153, for example. The authentication processing, which is performed on the basis of a message M1 generated by encryption using a time variant key, is controlled by the authentication unit 154. In addition, authentication processing that is performed on the basis of a MAC which is a message generated by encrypting data including the IDm using a time variant key is controlled by the authentication unit 154.

The encryption unit 155 performs a cryptographic operation on information to be transmitted to the IC card 2. Encryption of the data is performed by the cryptographic operation by the encryption unit 155.

The transmission unit 156 modulates information supplied from the encryption unit 155, for example, and causes the modulated information to be transmitted to the IC card 2 by being outputted to the antenna unit 151.

The random number generation unit 157 generates a random number.

The key generation unit 158 generates a time variant key on the basis of information supplied from the random number generation unit 157, for example, and supplies the time variant key to the decryption unit 153 and the encryption unit 155.

The storage unit 159 stores various items of information such as a program to be executed by a CPU in the R/W apparatus 1.

The interface 160 communicates with an external computer, and transmits an authentication result from the authentication unit 154 to the external computer.

An output from the reception unit 152 is supplied to, for example, the authentication unit 154, the encryption unit 155, and the key generation unit 158, in addition to the decryption unit 153. An output from the authentication unit 154 is supplied to, for example, the transmission unit 156 in addition to the encryption unit 155. An output from the random number generation unit 157 is supplied to, for example, the decryption unit 153, the authentication unit 154, the encryption unit 155, and the transmission unit 156, in addition to the key generation unit 158. An output from the key generation unit 158 is supplied to the authentication unit 154 in addition to the decryption unit 153 and the encryption unit 155.

For example, from among the processing in the steps included in the authentication sequence in FIG. 4, the processing in step S31 is performed by the random number generation unit 157. The processing in step S32 is performed by the transmission unit 156, and the processing in step S33 is performed by the reception unit 152. The processing in step S34 and step S35 is performed by the key generation unit 158, and the processing in step S36 is performed by the decryption unit 153. The processing in step S37 is performed by the authentication unit 154.

In addition, from among the processing in the steps included in the authentication sequence in FIG. 7, the processing in step S101 is performed by the random number generation unit 157. The processing in step S102 is performed by the transmission unit 156, and the processing in step S103 is performed by the reception unit 152. The processing in step S104 and step S105 is performed by the key generation unit 158, and the processing in step S106 is performed by the encryption unit 155. The processing in step S107 is performed by the authentication unit 154.

From among the processing in the steps included in the authentication sequence in FIG. 8 and FIG. 9, the processing in step S131 is performed by the random number generation unit 157. The processing in step S132 and step S139 is performed by the transmission unit 156, and the processing in step S133 and step S140 is performed by the reception unit 152. The processing in step S134 and step S135 is performed by the key generation unit 158, and the processing in step S136 and step S138 is performed by the encryption unit 155. The processing in step S137 is performed by the authentication unit 154.

The processing in each step for the R/W apparatus 1 included in the authentication sequences in FIG. 10 and subsequent figures is similarly performed by the corresponding unit in the R/W apparatus 1.

### Modifications

It has been assumed that the IC card 2 is an apparatus which communicates with the R/W apparatus 1, but it is possible to provide functionality of the IC card 2 described above in various apparatuses having an IC chip, such as a portable terminal or a PC.

For the R/W side, it is similarly possible to provide functionality of the R/W apparatus 1 described above in various apparatuses having R/W, such as a portable terminal or a PC.

It is possible to apply an authentication sequence as above to proximity communication performed between an R/W apparatus and an IC chip which supports a standard other than a FeliCa (registered trademark) standard.

### Example of a Configuration of a Computer

A series of processing described above can be executed by hardware, and can be executed by software. In a case where the series of processing is executed by software, a program which is included in this software is installed from a program recording medium onto a computer incorporated in dedicated hardware, a general-purpose personal computer, etc.

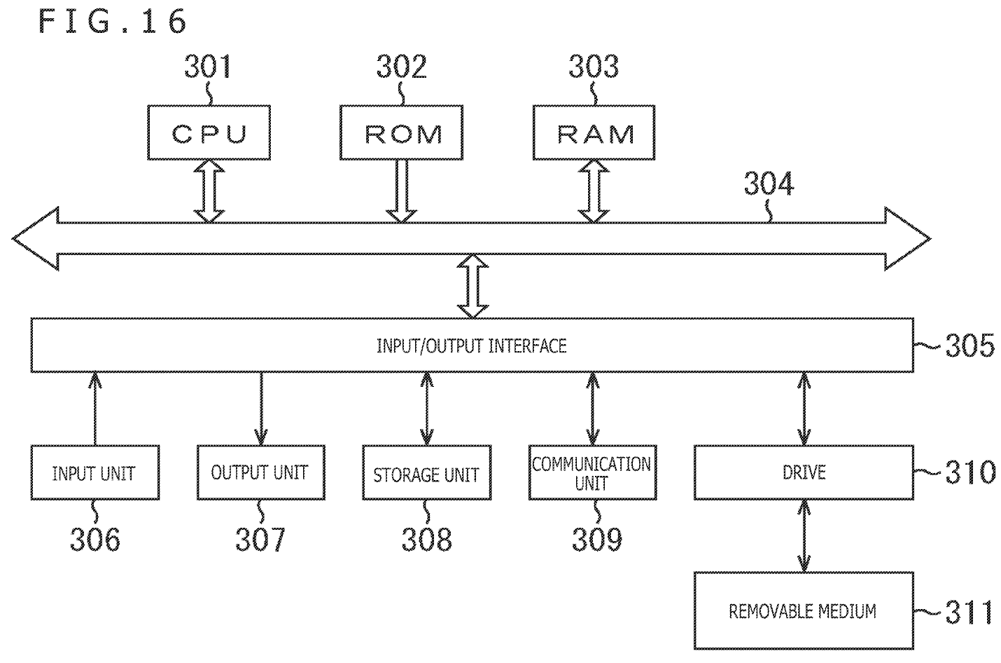

FIG. 16 is a block view illustrating an example of a configuration of hardware of a computer which executes, according to a program, the series of processing described above.

For example, a computer having the configuration illustrated in FIG. 16 is connected to the R/W apparatus 1, and it is possible to make it such that the processing described above is performed in the computer.

A CPU (Central Processing Unit) 301, a ROM (Read-Only Memory) 302, and a RAM (Random-Access Memory) 303 are connected to each other by a bus 304.

An input/output interface 305 is further connected to the bus 304. An input unit 306 including a keyboard, mouse, etc., and an output unit 307 including a display, speaker, etc., are connected to the input/output interface 305. In addition, a storage unit 308 including, for example, a hard disk or a non-volatile memory, a communication unit 309 including, for example, a network interface, and a drive 310 for driving a removable medium 311 are connected to the input/output interface 305.

In a computer configured as above, the series of processing described above is performed by the CPU 301, for example, by loading a program stored in the storage unit 308 into the RAM 303 via the input/output interface 305 and the bus 304 and executing the program.

The program to be executed by the CPU 301 is provided, for example, by being recorded to the removable medium 311 or via a wired or wireless transmission medium such as a local area network, the Internet, or digital broadcasting, and is installed into the storage unit 308.

A program executed by a computer may be a program for which processing is performed in chronological order following the order described in the present specification, or may be a program for which processing is performed in parallel or at necessary timings such as a timing when a call is performed.

In the present specification, a system means a set of multiple components (such as apparatuses or modules (components)), and it does not matter whether or not all components are inside the same case. Accordingly, multiple apparatuses which are accommodated in separate cases and are connected via a network, and one apparatus in which multiple modules are accommodated in one case are both systems.

Note that effects described in the present specification are purely exemplary, and effects are not limited to them. There may be other effects.

An embodiment of the present technique is not limited to the embodiments described above, and various modifications are possible within a scope that does not deviate from the gist of the present technique.

For example, the present technique can have a cloud computing configuration in which one function is apportioned among multiple apparatuses via a network and processing is jointly performed.

In addition, each step in the flow charts described above, in addition to being executed by one apparatus, can be executed by being apportioned among multiple apparatuses.

Further, in a case where multiple types of processing are included in one step, the multiple types of processing included in the one step, in addition to being executed by one apparatus, can be executed by being apportioned among multiple apparatuses.

### Example of Configuration Combinations

The present technique can also have the following configurations.

(1) An information processing apparatus including:

a reception unit configured to receive a first random number and a second random number that are transmitted from another information processing apparatus;

a random number generation unit configured to generate a third random number;

a time variant key generation unit configured to generate a first time variant key by causing the second random number and the third random number to act on a first fixed key;

an encryption unit configured to encrypt the first random number by using the first time variant key; and

a transmission unit configured to transmit the encrypted first random number and the third random number to the another information processing apparatus.

The information processing apparatus according to the abovementioned (1), further including:

a storage unit configured to store identification information regarding an IC chip provided in the information processing apparatus.

The information processing apparatus according to the abovementioned (2), further including:

an authentication unit configured to control authentication processing that is performed on the basis of a message generated by using the first time variant key to encrypt data including the identification information.

The information processing apparatus according to the abovementioned (3), in which

the encryption unit generates the message by using the first time variant key to encrypt data resulting from joining the first random number and the identification information, and

the transmission unit transmits the identification information, the third random number, and the message to the another information processing apparatus.

The information processing apparatus according to the abovementioned (3), in which

the random number generation unit generates the third random number and a fourth random number,

the encryption unit generates a first message by using the first time variant key to encrypt data resulting from joining the fourth random number, the first random number, and the identification information, and

the transmission unit transmits the fourth random number, the third random number, the identification information, and the first message to the another information processing apparatus.

The information processing apparatus according to the abovementioned (5), in which

the another information processing apparatus generates a second time variant key by causing the second random number and the third random number that is transmitted together with the first message, to act on the first fixed key, generates a second message by using the second time variant key to encrypt the fourth randomnumber, the first random number, and the identification information, and generates a third message by using the second time variant key to encrypt the first random number and the fourth random number in a case where authentication based on the first message and the second message is successful.

The information processing apparatus according to the abovementioned (6), in which

the reception unit receives the third message transmitted from the another information processing apparatus, and

the authentication unit performs the authentication processing on the basis of the third message and a fourth message that is generated by using the first time variant key to encrypt the first random number and the fourth random number.

The information processing apparatus according to the abovementioned (3), in which,

in a case where the authentication processing is successful, the authentication unit writes or reads out data to or from the storage unit.

An information processing method including:

by an information processing apparatus,

receiving a first random number and a second random number that are transmitted from another information processing apparatus;

generating a third random number;

generating a first time variant key by causing the second random number and the third random number to act on a first fixed key;

encrypting the first random number by using the first time variant key; and

transmitting the encrypted first random number and the third random number to the another information processing apparatus.

A program causing a computer to execute processing of:

receiving a first random number and a second random number that are transmitted from another information processing apparatus;

generating a third random number;

generating a first time variant key by causing the second random number and the third random number to act on a first fixed key;

encrypting the first random number by using the first time variant key; and

transmitting the encrypted first random number and the third random number to the another information processing apparatus.

An information processing apparatus including:

a random number generation unit configured to generate a first random number and a second random number;

a transmission unit configured to transmit the first random number and the second random number to another information processing apparatus;

a reception unit configured to receive, from the another information processing apparatus, a third random number that is generated in the another information processing apparatus and the first random number that is encrypted in the another information processing apparatus by using a first time variant key generated by causing the second random number and the third random number to act on a first fixed key;

a time variant key generation unit configured to generate a second time variant key by causing the third random number and the second random number that is generated by the random number generation unit, to act on a second fixed key that is the same fixed key as the first fixed key held by the another informationprocessing apparatus; and

an authentication unit configured to decrypt the encrypted first random number by using the second time variant key, and perform authentication processing on the basis of the first random number obtained by being decrypted and the first random number generated by the random number generation unit.

The information processing apparatus according to the abovementioned (11), in which

identification information is stored in an IC chip provided in the another information processing apparatus.

The information processing apparatus according to the abovementioned (12), in which

the authentication unit performs the authentication processing on the basis of a message generated by using the second time variant key to encrypt data including the identification information.

The information processing apparatus according to the abovementioned (13), in which

the reception unit receives the identification information, the third random number, and a first message that is generated in the another information processing apparatus by using the first time variant key to encrypt data resulting from joining the first random number and the identification information, and

the authentication unit performs the authentication processing on the basis of the first message and a second message that is generated by using the second time variant key to encrypt the first random number generated by the random number generation unit and the identification information received from the another information processing apparatus.

The information processing apparatus according to the abovementioned (13), in which,

in a case where the another information processing apparatus has generated a fourth random number together with the third random number and has generated a first message by using the first time variant key to encrypt data resulting from joining the fourth random number, the first random number, and the identification information,

the reception unit receives the fourth random number, the third random number, the identification information, and the first message.

The information processing apparatus according to the abovementioned (15), in which,

in a case where the authentication processing is successful, the transmission unit transmits, to the another information processing apparatus, a third message that is generated by using the second time variant key to encrypt the first random number generated by the random number generation unit and the fourth random number received from the another information processing apparatus.

An information processing method including:

by an information processing apparatus,

generating a first random number and a second random number;

transmitting the first random number and the second random number to another information processing apparatus;

receiving, from the another information processing apparatus, a third random number that is generated in the another information processing apparatus and the first random number that is encrypted in the another information processing apparatus by using a first time variant key generated by causing the second random number and the third random number to act on a first fixed key;

generating a second time variant key by causing the third random number and the generated second random number to act on a second fixed key that is the same fixed key as the first fixed key held by the another information processing apparatus;

decrypting the encrypted first random number by using the second time variant key; and

performing authentication processing on the basis of the first random number obtained by being decrypted and the generated first random number.

A program causing a computer to execute processing of:

generating a first random number and a second random number;

transmitting the first random number and the second random number to another information processing apparatus;

receiving, from the another information processing apparatus, a third random number that is generated in the another information processing apparatus and the first random number that is encrypted in the another information processing apparatus by using a first time variant key generated by causing the second random number and the third random number to act on a first fixed key;

generating a second time variant key by causing the third random number and the generated second random number to act on a second fixed key that is the same fixed key as the first fixed key held by the another information processing apparatus;

decrypting the encrypted first random number by using the second time variant key; and

performing authentication processing on the basis of the first random number obtained by being decrypted and the generated first random number.

An information processing system including:

an information processing apparatus including

a reception unit configured to receive a first random number and a second random number that are transmitted from another information processing apparatus,

a random number generation unit configured to generate a third random number,

a time variant key generation unit configured to generate a first time variant key by causing the second random number and the third random number to act on a first fixed key,

an encryption unit configured to encrypt the first random number by using the first time variant key, and

a transmission unit configured to transmit the encrypted first random number and the third random number to the another information processing apparatus; and

the another information processing apparatus including

a random number generation unit configured to generate the first random number and the second random number,

a transmission unit configured to transmit the first random number and the second random number to the information processing apparatus,

a reception unit configured to receive, from the information processing apparatus, the third random number and the first random number that is encrypted in the information processing apparatus by using the first time variant key,

a time variant key generation unit configured to generate a second time variant key by causing the third random number and the second random number that is generated by the random number generation unit, to act on a second fixed key that is the same fixed key as the first fixed key, and

an authentication unit configured to decrypt the encrypted first random number by using the second time variant key, and perform authentication processing on the basis of the first random number obtained by being decrypted and the first random number generated by the random number generation unit.

### REFERENCE SIGNS LIST

1: R/W apparatus
2: IC card
101: Antenna unit
102: Reception unit
103: Decryption unit
104: Authentication unit
105: Encryption unit
106: Transmission unit
107: Random number generation unit
108: Key generation unit
109: Storage unit
151: Antenna unit
152: Reception unit
153: Decryption unit
154: Authentication unit
155: Encryption unit
156: Transmission unit
157: Random number generation unit
158: Key generation unit
159: Storage unit
160: Interface

1. An information processing apparatus comprising:
a reception unit configured to receive a first random number and a second random number that are transmitted from another information processing apparatus;
a random number generation unit configured to generate a third random number;
a time variant key generation unit configured to generate a first time variant key by causing the second random number and the third random number to act on a first fixed key;
an encryption unit configured to encrypt the first random number by using the first time variant key; and
a transmission unit configured to transmit the encrypted first random number and the third random number to the another information processing apparatus.

2. The information processing apparatus according to claim 1, further comprising:
a storage unit configured to store identification information regarding an IC chip provided in the information processing apparatus.

3. The information processing apparatus according to claim 2, further comprising:
an authentication unit configured to control authentication processing that is performed on a basis of a message generated by using the first time variant key to encrypt data including the identification information.

4. The information processing apparatus according to claim 3, wherein
the encryption unit generates the message by using the first time variant key to encrypt data resulting from joining the first random number and the identification information, and
the transmission unit transmits the identification information, the third random number, and the message to the another information processing apparatus.

5. The information processing apparatus according to claim 3, wherein
the random number generation unit generates the third random number and a fourth random number,
the encryption unit generates a first message by using the first time variant key to encrypt data resulting from joining the fourth random number, the first random number, and the identification information, and
the transmission unit transmits the fourth random number, the third random number, the identification information, and the first message to the another information processing apparatus.

6. The information processing apparatus according to claim 5, wherein
the another information processing apparatus generates a second time variant key by causing the second random number and the third random number that is transmitted together with the first message, to act on the first fixed key, generates a second message by using the second time variant key to encrypt the fourth random number, the first random number, and the identification information, and generates a third message by using the second time variant key to encrypt the first random number and the fourth random number in a case where authentication based on the first message and the second message is successful.

7. The information processing apparatus according to claim 6, wherein
the reception unit receives the third message transmitted from the another information processing apparatus, and
the authentication unit performs the authentication processing on a basis of the third message and a fourth message that is generated by using the first time variant key to encrypt the first random number and the fourth random number.

8. The information processing apparatus according to claim 3, wherein,
in a case where the authentication processing is successful, the authentication unit writes or reads out data to or from the storage unit.

9. An information processing method comprising:
by an information processing apparatus,
receiving a first random number and a second random number that are transmitted from another information processing apparatus;
generating a third random number;
generating a first time variant key by causing the second random number and the third random number to act on a first fixed key;
encrypting the first random number by using the first time variant key; and
transmitting the encrypted first random number and the third random number to the another information processing apparatus.

10. A program causing a computer to execute processing of:
receiving a first random number and a second random number that are transmitted from another information processing apparatus;
generating a third random number;
generating a first time variant key by causing the second random number and the third random number to act on a first fixed key;
encrypting the first random number by using the first time variant key; and
transmitting the encrypted first random number and the third random number to the another information processing apparatus.

11. An information processing apparatus comprising:
a random number generation unit configured to generate a first random number and a second random number;
a transmission unit configured to transmit the first random number and the second random number to another information processing apparatus;
a reception unit configured to receive, from the another information processing apparatus, a third random number that is generated in the another information processing apparatus and the first random number that is encrypted in the another information processing apparatus by using a first time variant key generated by causing the second random number and the third random number to act on a first fixed key;
a time variant key generation unit configured to generate a second time variant key by causing the third random number and the second random number that is generated by the random number generation unit, to act on a second fixed key that is a same fixed key as the first fixed key held by the another information processing apparatus; and
an authentication unit configured to decrypt the encrypted first random number by using the second time variant key, and perform authentication processing on a basis of the first random number obtained by being decrypted and the first random number generated by the random number generation unit.

12. The information processing apparatus according to claim 11, wherein
identification information is stored in an IC chip provided in the another information processing apparatus.

13. The information processing apparatus according to claim 12, wherein
the authentication unit performs the authentication processing on a basis of a message generated by using the second time variant key to encrypt data including the identification information.

14. The information processing apparatus according to claim 13, wherein
the reception unit receives the identification information, the third random number, and a first message that is generated in the another information processing apparatus by using the first time variant key to encrypt data resulting from joining the first random number and the identification information, and
the authentication unit performs the authentication processing on a basis of the first message and a second message that is generated by using the second time variant key to encrypt the first random number generated by the random number generation unit and the identification information received from the another information processing apparatus.

15. The information processing apparatus according to claim 13, wherein,
in a case where the another information processing apparatus has generated a fourth random number together with the third random number and has generated a first message by using the first time variant key to encrypt data resulting from joining the fourth random number, the first random number, and the identification information,
the reception unit receives the fourth random number, the third random number, the identification information, and the first message.

16. The information processing apparatus according to claim 15, wherein,
in a case where the authentication processing is successful, the transmission unit transmits, to the another information processing apparatus, a third message that is generated by using the second time variant key to encrypt the first random number generated by the random number generation unit and the fourth random number received from the another information processing apparatus.

17. An information processing method comprising:
by an information processing apparatus,
generating a first random number and a second random number;
transmitting the first random number and the second random number to another information processing apparatus;
receiving, from the another information processing apparatus, a third random number that is generated in the another information processing apparatus and the first random number that is encrypted in the another information processing apparatus by using a first time variant key generated by causing the second random number and the third random number to act on a first fixed key;
generating a second time variant key by causing the third random number and the generated second random number to act on a second fixed key that is a same fixed key as the first fixed key held by the another information processing apparatus;
decrypting the encrypted first random number by using the second time variant key; and
performing authentication processing on a basis of the first random number obtained by being decrypted and the generated first random number.

18. A program causing a computer to execute processing of:
generating a first random number and a second random number;
transmitting the first random number and the second random number to another information processing apparatus;
receiving, from the another information processing apparatus, a third random number that is generated in the another information processing apparatus and the first random number that is encrypted in the another information processing apparatus by using a first time variant key generated by causing the second random number and the third random number to act on a first fixed key;
generating a second time variant key by causing the third random number and the generated second random number to act on a second fixed key that is a same fixed key as the first fixed key held by the another information processing apparatus;
decrypting the encrypted first random number by using the second time variant key; and
performing authentication processing on a basis of the first random number obtained by being decrypted and the generated first random number.

19. An information processing system comprising:
an information processing apparatus including
a reception unit configured to receive a first random number and a second random number that are transmitted from another information processing apparatus,
a random number generation unit configured to generate a third random number,
a time variant key generation unit configured to generate a first time variant key by causing the second random number and the third random number to act on a first fixed key,
an encryption unit configured to encrypt the first random number by using the first time variant key, and
a transmission unit configured to transmit the encrypted first random number and the third random number to the another information processing apparatus; and
the another information processing apparatus including
a random number generation unit configured to generate the first random number and the second random number,
a transmission unit configured to transmit the first random number and the second random number to the information processing apparatus,
a reception unit configured to receive, from the information processing apparatus, the third random number and the first random number that is encrypted in the information processing apparatus by using the first time variant key,
a time variant key generation unit configured to generate a second time variant key by causing the third random number and the second random number that is generated by the random number generation unit, to act on a second fixed key that is a same fixed key as the first fixed key, and
an authentication unit configured to decrypt the encrypted first random number by using the second time variant key, and perform authentication processing on a basis of the first random number obtained by being decrypted and the first random number generated by the random number generation unit.
